(19) United States
(12) Patent Application Publication
(10) Pub. No.: US 2009/0284627 A1
(43) Pub. Date: Nov. 19, 2009

(54) Image processing Method

(75) Inventors: Yosuke Bando, Fuchu-shi (JP); Tomoyuki Nishita, Tokyo (JP)

Correspondence Address: SPRINKLE IP LAW GROUP, 1301 W. 25TH STREET, SUITE 408, AUSTIN, TX, 78705, US

(73) Assignee: KAIBUSHIKI KAISHA TOSHIBA, Tokyo (JP)

(21) Appl. No.: 12/381,201

(22) Filed: Mar. 9, 2009

(30) Foreign Application Priority Data
May 16, 2008 (JP) 2008-130005

(51) Int. Cl. H04N 5/335; G06K 9/34; G06K 9/40

(52) U.S. Cl. 348/273; 382/173; 382/255

(57) ABSTRACT

An image processing method includes photographing an object by a camera via a filter, separating image data, which is obtained by photographing by the camera, into a red component, a green component and a blue component, determining a relationship of correspondency between pixels in the red component, the green component and the blue component, with reference to departure of pixel values in the red component, the green component and the blue component from a linear color model in a three-dimensional color space, and finding a depth of each of the pixels in the image data in accordance with positional displacement amounts of the corresponding pixels of the red component, the green component and the blue component. The image processing method further includes processing the image data in accordance with the depth.

### CROSS-REFERENCE TO RELATED APPLICATIONS

This application is based upon and claims the benefit of priority from prior Japanese Patent Application No. 2008-130005, filed May 16, 2008, the entire contents of which are incorporated herein by reference.

### BACKGROUND OF THE INVENTION

1. Field of the Invention

The present invention relates to an image processing method. The invention relates more particularly to a method of estimating the depth of a scene and a method of extracting a foreground of the scene in an image processing system.

2. Description of the Related Art

Conventionally, there are known various methods of estimating the depth of a scene, as image processing methods in image processing systems. Such methods include, for instance, a method in which a plurality of images of an object of photography are acquired by varying the pattern of light by means of, e.g. a projector, and a method in which an object is photographed from a plurality of view points by shifting the position of a camera or by using a plurality of cameras. In these methods, however, there are such problems that the scale of the photographing apparatus increases, the cost is high, and the installation of the photographing apparatus is time-consuming.

To cope with these problems, there has been proposed a method of estimating the depth of a scene by using a single image which is taken by a single camera (document 1). In the method of document 1, a camera is equipped with a micro-lens array, and an object is photographed substantially from a plurality of view points. However, in this method, the fabrication of the camera becomes very complex. Moreover, there is such a problem that the resolution of each image deteriorates since a plurality of images are included in a single image.

Also proposed is a method of estimating the depth of a scene by using a color filter (document 2), (document 3). The method of document 2 is insufficient in order to compensate for a luminance difference between images which are recorded with different wavelength bands, and only results with low precision are obtainable. Further, in the method of document 3, scaling is performed for making equal the sum of luminance in a local window. However, in the method of document 3, it is assumed that a dot pattern is projected on an object, which is the object of photography, by a flash, and sharp edges are densely included in an image. Accordingly, a special flash is needed and, moreover, in order to perform image edit, the same scene needs to be photographed once again without lighting a flash.

Conventionally, in the method of extracting a foreground of a scene, a special photographing environment, such as an environment in which a foreground is photographed in front of a single-color background, is presupposed. Manual work is indispensable in order to extract a foreground object with a complex contour from an image which is acquired in a general environment. Thus, there is proposed a method in which photographing is performed by using a plurality of cameras from a plurality of view points or under a plurality of different photographing conditions (document 4), (document 5). However, in the methods of documents 4 and 5, there are such problems that the scale of the photographing apparatus increases, the cost is high, and the installation of the photographing apparatus is time-consuming.

### BRIEF SUMMARY OF THE INVENTION

According to an aspect of the present invention, there is provided an image processing method comprising: photographing an object by a camera via a filter including a first filter region which passes red light, a second filter region which passes green light and a third filter region which passes blue light; separating image data, which is obtained by photographing by the camera, into a red component, a green component and a blue component; determining a relationship of correspondency between pixels in the red component, the green component and the blue component, with reference to departure of pixel values in the red component, the green component and the blue component from a linear color model in a three-dimensional color space; finding a depth of each of the pixels in the image data in accordance with positional displacement amounts of the corresponding pixels of the red component, the green component and the blue component; and processing the image data in accordance with the depth.

### BRIEF DESCRIPTION OF THE SEVERAL VIEWS OF THE DRAWING

The file of this patent contains photographs executed in color. Copies of this patent with color photographs will be provided by the Patent and Trademark Office upon request and payment of the necessary fee.

FIG. 1 is a block diagram showing a structure example of an image processing system according to a first embodiment of the present invention;

FIG. 2 is a structural view showing an example of a filter according to the first embodiment of the invention;

FIG. 3 is a view showing the external appearance of a lens part of a camera according to the first embodiment of the invention;

FIG. 4 is a flow chart for explaining an image processing method according to the first embodiment of the invention;

FIG. 5 is a copy of an image photograph used in place of a drawing, including a reference image which is acquired by a camera, and an R image, a G image and a B image which extract corresponding RGB components;

FIG. 6 schematically shows a state in which a foreground object is photographed by the camera according to the first embodiment of the invention;

FIG. 7 schematically shows a state in which a background is photographed by the camera according to the first embodiment of the invention;

FIG. 8 is a view for explaining the relationship between the reference image, the R image, the G image and the B image in the image processing method according to the first embodiment of the invention;

FIG. 9 is a view for explaining a color distribution in an RGB color space, which is obtained by the image processing method according to the first embodiment of the invention;

FIG. 10 is a view that schematically shows a state in which candidate images are created in the image processing method according to the first embodiment of the invention;

FIG. 11 is a schematic view showing a candidate image which is obtained by the image processing method according to the first embodiment of the invention;

FIG. 12 is a view for explaining color distributions in an RGB color space, which are obtained by the image processing method according to the first embodiment of the invention;

FIG. 13 is a view showing an estimation result of the color displacement amounts which are obtained by the image processing method according to the first embodiment of the invention;

FIG. 14 is a view showing an estimation result of the color displacement amounts which are obtained by the image processing method according to the first embodiment of the invention;

FIG. 15 is a flow chart for explaining the image processing method according to the first embodiment of the invention;

FIG. 16 shows a trimap which is obtained by the image processing method according to the first embodiment of the invention;

FIG. 17 shows color displacement amounts in a background and an unknown area, which are obtained by the image processing method according to the first embodiment of the invention;

FIG. 18 shows color displacement amounts in a foreground and an unknown area, which are obtained by the image processing method according to the first embodiment of the invention;

FIG. 19 is a view showing an example of a background color which is obtained by the image processing method according to the first embodiment of the invention;

FIG. 20 is a view showing an example of a foreground color which is obtained by the image processing method according to the first embodiment of the invention;

FIG. 21 is a view showing a mask image which is obtained by the image processing method according to the first embodiment of the invention;

FIG. 22 is a view showing a composite image which is obtained by the image processing method according to the first embodiment of the invention; and

FIGS. 23A to 23G are structural views showing other examples of filters according to a third embodiment of the invention.

### DETAILED DESCRIPTION OF THE INVENTION

Embodiments of the present invention will be described with reference to the accompanying drawings. It should be noted that the drawings are schematic ones and so are not to scale. The following embodiments are directed to a device and a method for embodying the technical concept of the present invention and the technical concept does not specify the material, shape, structure or configuration of components of the present invention. Various changes and modifications can be made to the technical concept without departing from the scope of the claimed invention.

### First Embodiment

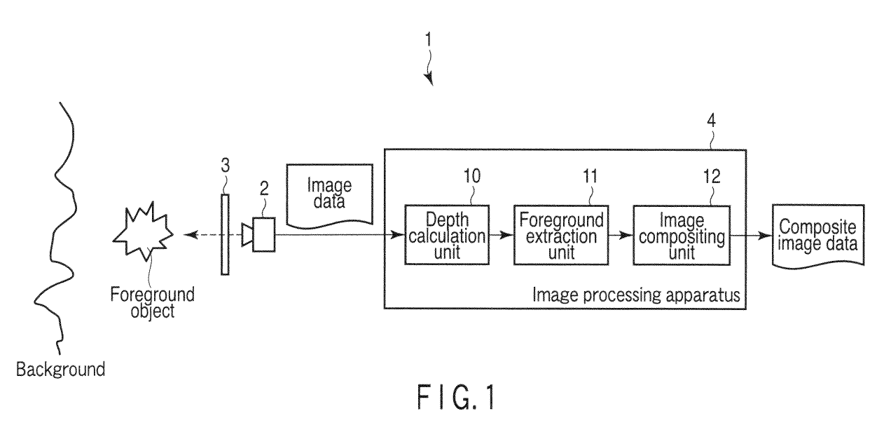

An image processing method according to a first embodiment of the present invention will now be described with reference to FIG. 1. FIG. 1 is a block diagram of an image processing system according to the present embodiment.

As shown in FIG. 1, the image processing system 1 includes a camera 2, a filter 3 and an image processing apparatus 4. The camera 2 photographs an object of photography (a foreground object and a background), and outputs acquired image data to the image processing apparatus 4.

The image processing apparatus 4 includes a depth calculation unit 10, a foreground extraction unit 11 and an image compositing unit 12. The depth calculation unit 10 calculates the depth in a photographed image by using the image data that is delivered from the camera 2. On the basis of the magnitude of the depth that is calculated by the depth calculation unit 10, the foreground extraction unit 11 extracts a foreground corresponding to the foreground object in the photographed image. The image compositing unit 12 executes various image processes, such as a process of generating composite image data by compositing the foreground extracted by the foreground extraction unit 11 with some other background image.

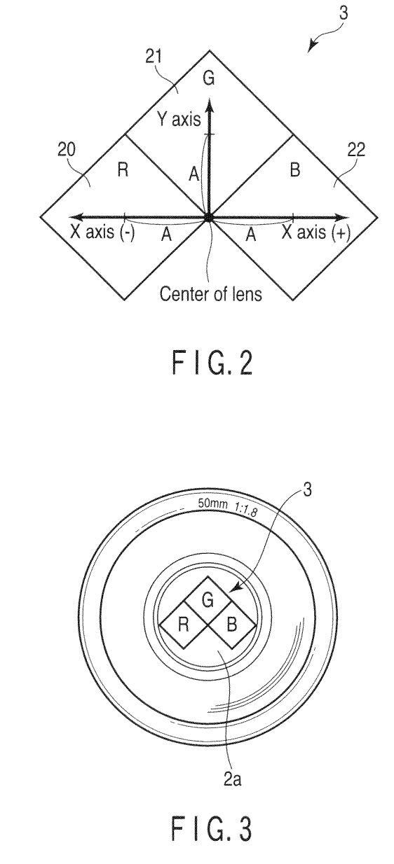

The filter 3 is described with reference to FIG. 2. FIG. 2 is an external appearance view of the structure of the filter 3, and shows a plane parallel to an image pickup plane of the camera 2, as viewed in the frontal direction. As shown in FIG. 2, the filter 3 includes, in the plane parallel to the image pickup plane of the camera 2, a filter region 20 (hereinafter referred to as “red filter 20”) which passes only a red component (R component), a filter region 21 (hereinafter “green filter 21”) which passes only a green component (G component), and a filter region 22 (hereinafter “blue filter 22”) which passes only a blue component (B component). In the filter 3 in this embodiment, the red filter 20, green filter 21 and blue filter 22 have a relationship of congruence. The centers of the filters 20 to 22 are present at equidistant positions in an X axis (right-and-left direction in the plane of photography) or a Y axis (up-and-down direction in the image pickup plane) with respect to the position corresponding to the optical center of the lens (i.e. the center of the aperture)

The camera 2 photographs the object of photography by using such filter 3. The filter 3 is provided, for example, at the part of the aperture of the camera 2.

FIG. 3 is an external appearance view of the lens part of the camera 2. As shown in FIG. 3, the filter 3 is disposed at the part of the aperture of the camera 2. Light is incident on the image pickup plane of the camera 2. In FIG. 1, the filter 3 is depicted as being disposed on the outside of the camera 2. However, it is preferable that the filter 3 be disposed within the lens 2a of the camera 2.

Next, the details of the depth calculation unit 10, foreground extraction unit 11 and image compositing unit 12 are described.

### <<Re: Depth Calculation Unit 10>>

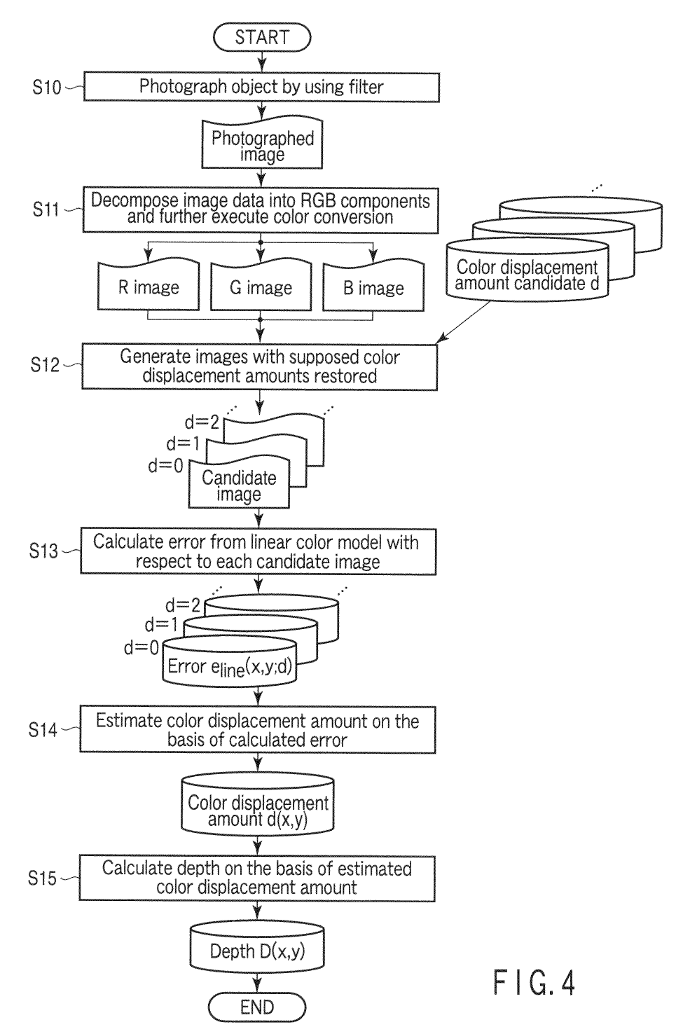

FIG. 4 is a flow chart illustrating the operation of the camera 2 and depth calculation unit 10. A description will be given of the respective steps in the flow chart.

### <Step S10>

To start with, the camera 2 photographs an object of photography by using the filter 3. The camera 2 outputs image data, which is acquired by photography, to the depth calculation unit 10.

### <Step S11>

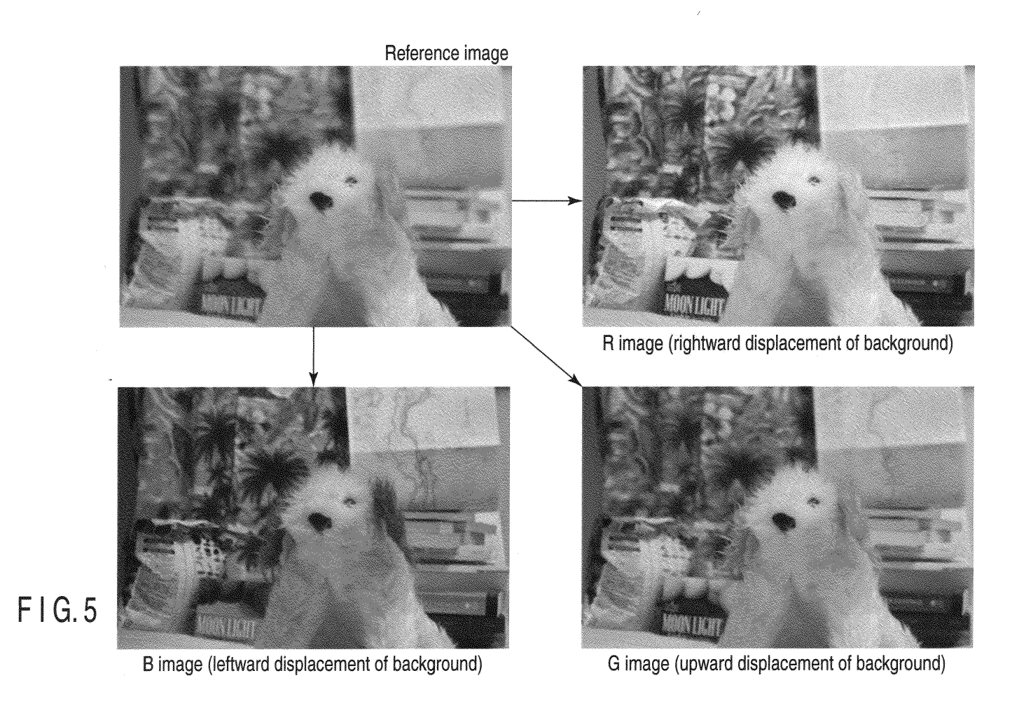

Subsequently, the depth calculation unit 10 decomposes the image data into a red component, a green component and a blue component. FIG. 5 shows an image (RGB image) which is photographed by using the filter 3 shown in FIG. 2, and images of an R component, a G component and a B component (hereinafter also referred to as “R image”, “G image” and “B image”, respectively) of this image.

As shown in FIG. 5, the R component of the background, which is located farther than an in-focus foreground object (a stuffed toy dog in FIG. 5), is displaced to the right, relative to a virtual image of a central view point, in other words, a virtual RGB image without color displacement (hereinafter referred to as “reference image”). Similarly, the G component is displaced in the upward direction, and the B component is disposed to the left. In the meantime, since FIG. 2 and FIG. 3 are views taken from the outside of the lens 2a, the right-and-left direction of displacement in the photographed image is reversed.

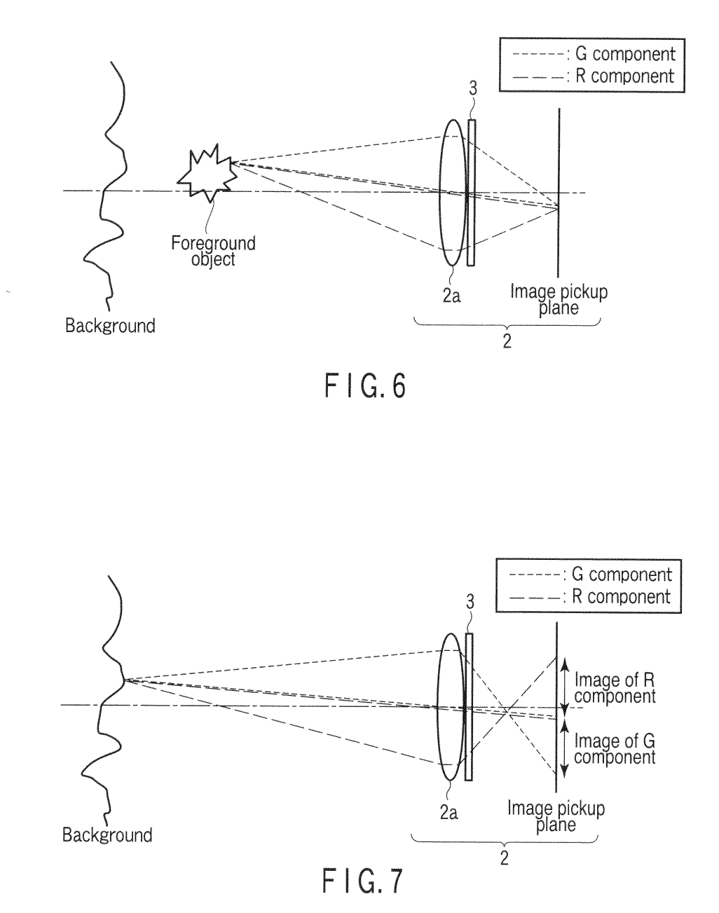

The principle of such displacement of the respective background components relative to the reference image is explained with reference to FIG. 6 and FIG. 7.

FIG. 6 and FIG. 7 are schematic views of the object of photography, the camera 2 and the filter 3, and show the directions of light rays along the optical axis, which are incident on the camera 2. FIG. 6 shows the state in which an arbitrary point on an in-focus foreground object is photographed, and FIG. 7 shows the state in which an arbitrary point on an out-of-focus background is photographed. In FIG. 6 and FIG. 7, for the purpose of simple description, it is assumed that the filter includes only the red filter 20 and green filter 21, and the red filter 20 is disposed on the lower side of the optical axis of the filter and the green filter 21 is disposed on the upper side of the optical axis of the filter.

As shown in FIG. 6, in the case where an in-focus foreground object is photographed, both the light passing through the red filter 20 and the light passing through the green filter 21 converge on the same point on the image pickup plane. On the other hand, as shown in FIG. 7, in the case where an out-of-focus background is photographed, the light passing through the red filter 20 and the light passing through the green filter 21 are displaced in opposite directions, and fall on the image pickup plane with focal blurring.

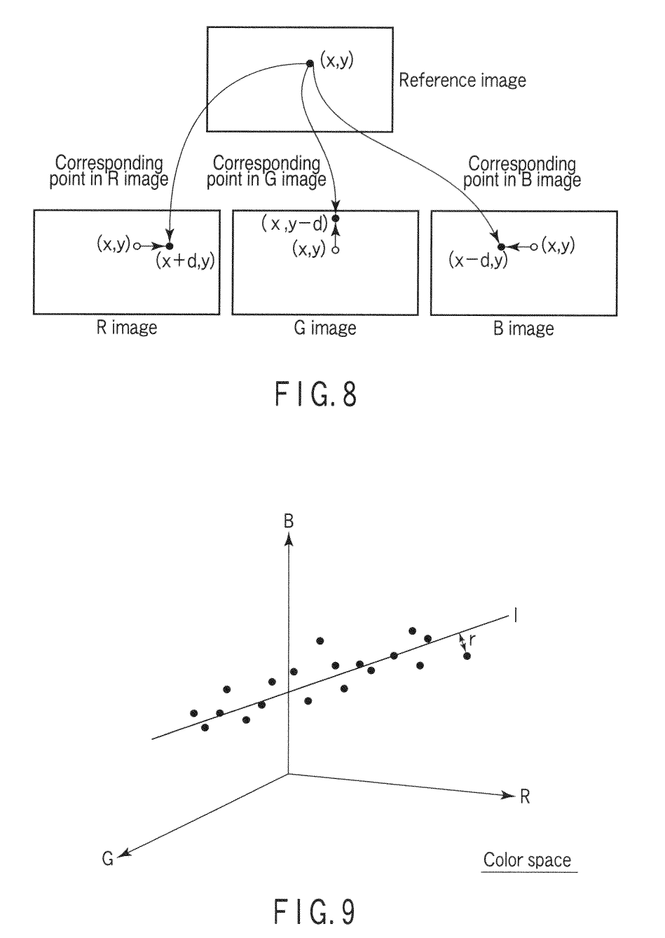

The displacement of the light is explained in brief with reference to FIG. 8.

FIG. 8 is a schematic view of the reference image, R image, G image and B image.

In the case where the filter shown in FIG. 2 is used, a point at coordinates (x,y) in the reference image (or scene) is displaced rightward in the R image, as shown in FIG. 8. The point at coordinates (x,y) is displaced upward in the G image, and displaced leftward in the B image. The displacement amount d is equal in the three components. Specifically, the coordinates of the point corresponding to (x,y) in the reference image is (x+d, y) in the R image, (x, y−d) in the G image, and (x−d, y) in the B image. The displacement amount d depends on the depth D. In the ideal thin lens, the relationship of the following equation (1) is established:

1/D=1/F−(1+d/A)/v (1)

where F is the focal distance of the lens 2a, A is the displacement amount from the center of the lens 2a to the center of the filter, 20-22 (see FIG. 2), and v is the distance between the lens 2a and the image pickup plane. In equation (1), the displacement amount d is a value which is expressed by the unit (e.g. mm) of length on the image pickup plane. In the description below, however, the displacement amount d is treated as a value which is expressed by the unit (pixel) of the number of pixels.

In equation (1), if d=0, the point (x,y) is in focus, and the depth at this time is D=1/(1/F−1/v). The depth D at the time of d=0 is referred to as “D₀.” In the case of d>0, as the value |d| (absolute value) is greater, the point (x,y) is present at a farther position from the point where the depth D is D₀. The depth D at this time is D>D₀. Conversely, in the case of d<0, as the value |d| (absolute value) is greater, the point (x,y) is present at a nearer position from the point where the depth D is D₀, and the depth D at this time is D<D₀. In the case of d<0, the direction of displacement is reverse to the case of d>0, and the R component is displaced leftward, the G component is displaced downward and the B component is displaced rightward.

The depth calculation unit 10 separates the R image, G image and B image from the RGB image as described above, and subsequently executes color conversion. The color conversion is explained below.

It is ideal that there is no overlap of wavelengths in the transmissive lights of the three filters 20 to 22. Actually, however, light of a wavelength in a certain range may pass through color filters of two or more colors. In addition, in general, the characteristics of the color filters and the sensitivity to red R, green G and blue B light components of the image pickup plane of the camera are different. Thus, the light that is recorded as a red component on the image pickup plane is not necessarily only the light that has passed through the red filter 20, and may include, in some cases, transmissive light of, e.g. the green filter 21.

To cope with this problem, the R component, G component and B component of the captured image are not directly used, but are subjected to conversion, thereby minimizing the interaction between the three components. Specifically, as regards the R image, G image and B image, raw data of the respective recorded lights are set as Hr (x,y), Hg (x,y) and Hb (x,y), and the following equation (2) is applied:

$${( Ir ( x , y ) , Ig ( x , y ) , Ib ( x , y ) )}^{T} = {M ( Hr ( x , y ) , Hg ( x , y ) , Hb ( x , y ) )}^{T} \qquad ( 2 )$$

where T indicates transposition, and M indicates a color conversion matrix. M is defined by the following equation:

M=(Kr, Kg, Kb)⁻¹ (3)

In equation (3) “−1” indicates an inverse matrix. Kr is a vector indicating an (R,G,B) component of raw data which is obtained when a white object is photographed by the red filter 20 alone. Kg is a vector indicating an (R,G,B) component of raw data which is obtained when a white object is photographed by the green filter 21 alone. Kb is a vector indicating an (R,G,B) component of raw data which is obtained when a white object is photographed by the blue filter 22 alone.

Using the R image, G image and B image which are obtained by the above-described color conversion, the depth calculation unit 10 calculates the depth D by the process of steps S12 to S15.

### <<Basic Concept of Calculation Method of Depth D>>

To begin with, the basic concept for calculating the depth D is explained. As has been described above, the obtained R image, G image and B image become a stereo image of three view points. As has been described with reference to FIG. 8, if the displacement amount d at the time when the point at the coordinates (x,y) in the reference image is photographed in the R image, G image and B image is found, the depth D is calculated by the above equation (1).

Hence, by evaluation using some measure, it is determined whether the value (pixel value) Ir (x+d, y) of the R image, the value Ig (x,y−d) of the G image and the value Ib (x−d, y) of the B image are obtained by photographing the same point in the scene.

The measure, which is used in the conventional stereo matching method, is based on the difference between pixel values, and uses, for example, the following equation (4):

e_{diff}(x,y;d)=Σ_{(s,t)}∈_{w(x,y)}|Ir(s+d, t)−Ig(s, t−d)|² (4)

where e_{diff} (x,y; d) is dissimilarity at the time when the displacement at (x,y) is supposed/assumed to be d. As the value of e_{diff} (x,y; d) is smaller, the likelihood of the point's correspondence is regarded as being higher. And, w (x,y) is a local window centering on (x,y), and (s,t) is coordinates within (x,y). Since the reliability of evaluation based on only one point is low, neighboring pixels are, in general, also taken into account.

However, the recording wavelengths of the R image, G image and B image are different from each other. Thus, even if the same point on the scene is photographed, the pixel values are not equal in the three components. Hence, there may be a case in which it is difficult to correctly estimate the corresponding point by the measure of the above equation (4).

To cope with this problem, in the present embodiment, the dissimilarity of the corresponding point is evaluated by making use of the correlation between the images of the respective color components. In short, use is made of the characteristic that the distribution of the pixel values, if observed locally, is linear in a three-dimensional color space in a normal natural image which is free from color displacement (this characteristic is referred to as “linear color model”). For example, if consideration is given to a set of points, {(Jr (s,t), Jg (s,t), Jb (s,t))|(s,t) ∈_{w} (x,y)}, around an arbitrary point (x,y) of an image J which is free from color displacement, the distribution of pixel values, in many cases, becomes linear, as shown in FIG. 9.

FIG. 9 is a graph plotting pixel values at respective coordinates in w (x,y) in the (R,G,B) three-dimensional color space. On the other hand, if color displacement occurs, the above relationship is not established. In other words, the distribution of pixel values does not become linear.

In the present embodiment, when it is supposed that the color displacement amount is d, as shown in FIG. 8, a straight line (straight line 1 in FIG. 9) is fitted to a set of points, P={(Ir (s+d, t), Ig (s, t−d) , Ib (s−d, t))|(s,t) ∈_{w} (x,y)}, around the supposed corresponding points, Ir (x+d, t), Ig (x, y−d), Ib (x−d, y). The average of squares of the distances (distance r in FIG. 9) between the fitted straight line and the respective points is considered to be an error eₗᵢₙₑ (x,y; d) from this straight line (linear color model).

The straight line 1 is the principal axis of the above-described set of points, P. To begin with, the covariance matrix Sij of the set of points, P, is calculated in a manner as expressed by the following equation (5):

S₀₀=var(Ir)=Σ(Ir(s+d, t)−avg(Ir))²/N

S₁₁=var(Ig)=Σ(Ig(s, t−d)−avg(Ig))²/N

S₂₂=var(Ib)=Σ(Ib(s−d, t)−avg(Ib))²/N

S₀₁=S₁₀=cov(Ir,Ig)=Σ(Ir(s+d, t)−avg(Ir))(Ig(s, t−d)−avg(Ig))/N

S₀₂=S₂₀=cov(Ib,Ir)=Σ(Ib(s−d, t)−avg(Ib))(Ir(s+d, t)−avg(Ir))/N

S₁₂=S₂₁=cov(Ig,Ib)=Σ(Ig(s, t−d)−avg(Ig))(Ib(s−d, t)−avg(Ib))/N (5)

where Sij is an (i,j) component of the (3×3) matrix S, and N is the number of points included in the set of points, P. In addition, var (Ir), var (Ig) and var (Ib) are variances of the respective components, and cov (Ir,Ig), cov (Ig,Ib) and cov (Ib,Ir) are covariances between two components. Further, avg (Ir), avg (Ig) and avg (Ib) are averages of the respective components, and are expressed by the following equation (6):

avg(Ir)=ΣIr(s+d, t)/N

avg(Ig)=ΣIg(s, t−d)/N

avg(Ib)=ΣIb(s−d, t)/N (6)

Specifically, the straight line 1 of the set of points, P, is the eigenvector for the largest eigenvalue λₘₐₓ of the covariance matrix S. Therefore, the relationship of the following equation (7) is satisfied:

λₘₐₓ1=S1 (7)

The largest eigenvalue and the eigenvector can be found, for example, by a power method. Using the largest eigenvalue, the error eₗᵢₙₑ (x,y; d) from the linear color model can be found by the following equation (8):

eₗᵢₙₑ(x,y; d)=S₀₀+S₁₁+S₂₂−λₘₐₓ (8)

If the error eₗᵢₙₑ (x,y; d) is large, it is highly possible that the supposition that “the color displacement amount is d” is incorrect. It can be estimated that the value d, at which the error eₗᵢₙₑ (x,y; d) becomes small, is the correct color displacement amount. The smallness of the error eₗᵢₙₑ (x,y; d) suggests that the colors are aligned (not displaced). In other words, images with displaced colors are restored to the state with no color displacement, and it is checked whether the colors are aligned.

By the above-described method, the measure of the dissimilarity between images with different recording wavelengths can be created. The depth D is calculated by using the conventional stereo matching method with use of this measure.

Next, concrete process steps are described.

### <Step S12>

To begin with, the depth calculation unit 10 supposes a plurality of color displacement amounts d, and creates a plurality of images by restoring (canceling) the supposed color displacement amounts. Specifically, a plurality of displacement amounts d are supposed with respect to the coordinates (x,y) in the reference image, and a plurality of images (referred to as “candidate images”), in which these supposed displacement amounts are restored, are obtained.

FIG. 10 is a schematic view showing the state in which candidate images are obtained in the case where d=−10, −9, . . . , −1, 0, 1, . . . , 9, 10 are supposed with respect to the coordinates (x,y) of the reference image. In FIG. 10, the relationship between the pixel at the coordinates of x=x1 and y=y1 in the reference image and the corresponding points of this pixel are shown.

As shown in FIG. 10, for example, if d=10 is supposed, this means that it is supposed that the corresponding point in the R image, which corresponds to the coordinates (x,y) in the reference image, is displaced rightward by 10 pixels (x1+10, y1). In addition, it is supposed that the corresponding point in the G image, which corresponds to the coordinates (x,y) in the reference image, is displaced upward by 10 pixels (x1, y1−10), and the corresponding point in the B image, which corresponds to the coordinates (x,y) in the reference image, is displaced leftward by 10 pixels (x1−10, y1).

Thus, with the restoration of these displacements, a candidate image is created. Specifically, the R image is displaced leftward by 10 pixels, the G image is displaced downward by 10 pixels, and the B image is displaced rightward by 10 pixels. A resultant image, which is obtained by compositing these images, becomes a candidate image in the case of d=10. Accordingly, the R component of the pixel value at the coordinates (x,y) of the candidate image is the pixel value at the coordinates (x1+10, y1) of the R image. The G component of the pixel value at the coordinates (x,y) of the candidate image is the pixel value at the coordinates (x1, y1−10) of the G image. The B component of the pixel value at the coordinates (x,y) of the candidate image is the pixel value at the coordinates (x1−10, y1) of the B image.

In the same manner, 21 candidate images of d=−10˜+10 are prepared.

### <Step S13>

Next, in connection with the 21 candidate images which are obtained in the above step S12, the depth calculation unit 10 calculates the error eₗᵢₙₑ (x,y; d) from the linear color model with respect to all pixels.

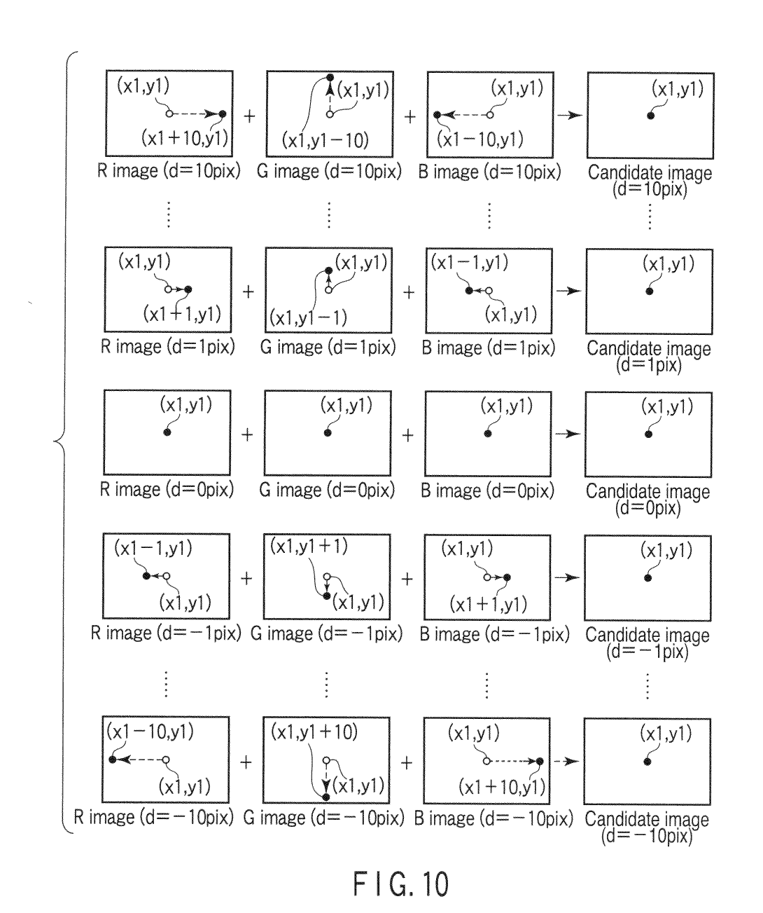

FIG. 11 is a schematic diagram showing one of candidate images, in which any one of the displacement amounts d is supposed. FIG. 11 shows the state at the time when the error eₗᵢₙₑ (x,y; d) from the linear color model is to be found with respect to the pixel corresponding to the coordinates (x1,y1).

As shown in FIG. 11, in each candidate image, a local window w (x1,y1), which includes the coordinates (xy,y1) and includes a plurality of pixels neighboring the coordinates (xy,y1), is supposed. In the example of FIG. 11, the local window w (x1,y1) includes nine pixels P0 to P8.

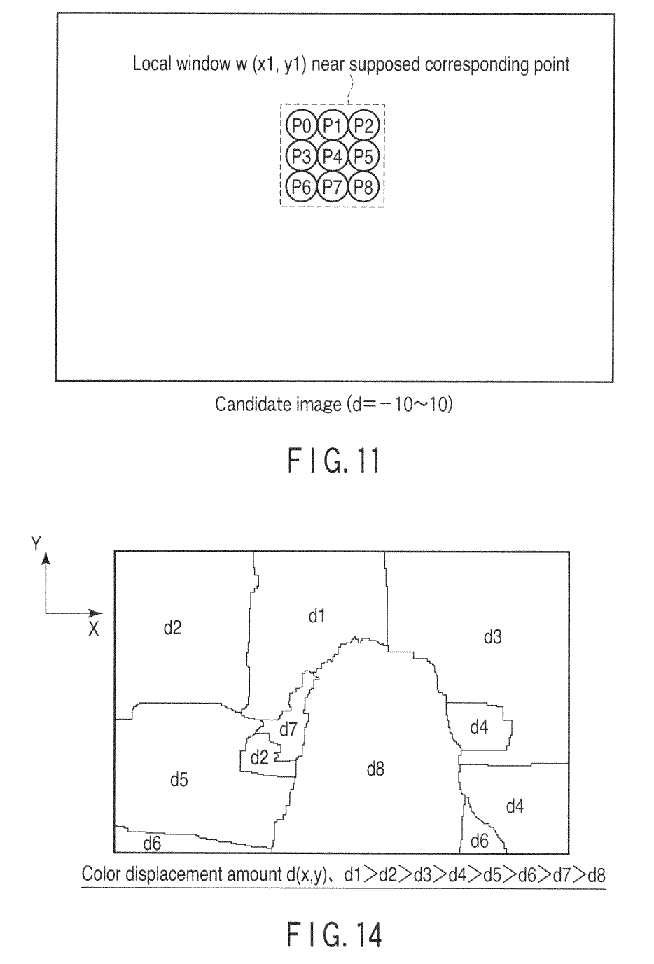

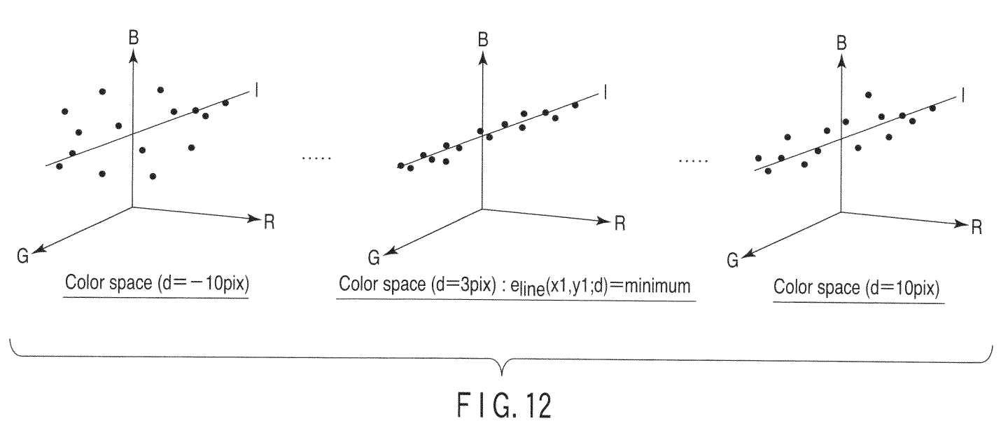

In each candidate image, a straight line 1 is found by using the above equations (5) to (7). Further, with respect to each candidate image, the straight line 1 and the pixel values of R, G and B at pixels P0 to P8 are plotted in the (R,G,B) three-dimensional color space, and the error eₗᵢₙₑ (x,y; d) from the linear color model is calculated. The error eₗᵢₙₑ (x,y; d) can be found from the above equation (8). For example, assume that the distribution in the (R,G,B) three-dimensional color space of the pixel colors within the local window at the coordinates (x1,y1) is as shown in FIG. 12.

FIG. 12 is a graph showing the distribution in the (R,G,B) three-dimensional color space of the pixel colors within the local window at the coordinates (x1,y1). FIG. 12 relates to an example of the case in which the error eₗᵢₙₑ (x,y; d) is minimum at the time of d=3.

### <Step S14>

Next, on the basis of the error eₗᵢₙₑ (x,y; d) which is obtained in step S13, the depth calculation unit 10 estimates a correct color displacement amount d with respect to each pixel. In this estimation process, the displacement amount d, at which the error eₗᵢₙₑ (x,y; d) becomes minimum at each pixel, is chosen. Specifically, in the case of the example of FIG. 12, the correct displacement amount d (x1,y1) at the coordinates (x1,y1) is three pixels. The above estimation process is executed with respect to all pixels of the reference image.

By the present process, the ultimate color displacement amount d (x,y) is determined with respect to all pixels of the reference image.

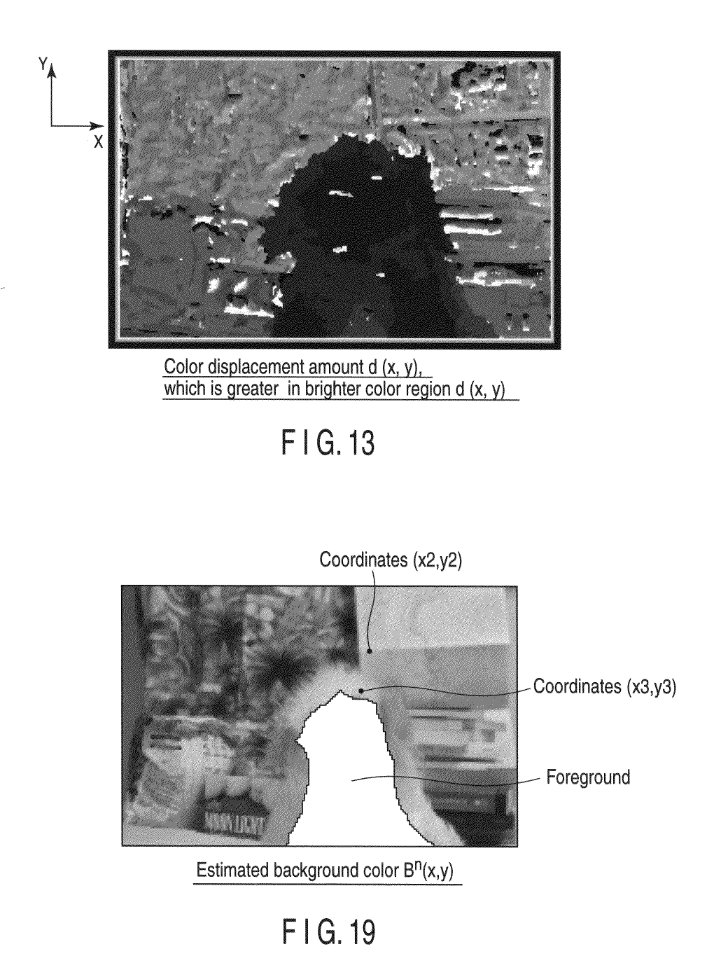

FIG. 13 is a view showing color displacement amounts d with respect to RGB images shown in FIG. 5. In FIG. 13, the color displacement amount d (x,y) is greater in a region having a higher brightness. As shown in FIG. 13, the color displacement amount d (x,y) is small in the region corresponding to the in-focus foreground object (the stuffed toy dog in FIG. 5), and the color displacement amount d (x,y) becomes greater at positions closer to the background.

In step S14, if the color displacement amount d (x,y) is estimated independently in each local window, the color displacement amount d (x,y) tends to be easily affected by noise. Thus, the color displacement amount d (x,y) is estimated, for example, by a graph cut method, in consideration of the smoothness of estimation values between neighboring pixels. FIG. 14 shows the result of the estimation.

### <Step S15>

Next, the depth calculation unit 10 determines the depth D (x,y) in accordance with the color displacement amount d (x,y) which has been determined in step S14. If the color displacement amount d (x,y) is 0, the associated pixel corresponds to the in-focus foreground object, and the depth D is D=D₀, as described above. On the other hand, if d>0, the depth D becomes D>D₀ as |d| becomes greater. Conversely, if d<0, the depth D becomes D<D₀ as |d| becomes greater.

In this step S15, the configuration of the obtained depth D (x,y) is the same as shown in FIG. 14.

Thus, the depth D (x,y) relating to the image that is photographed in step S10 is calculated.

### <<Re: Foreground Extraction Unit 11>>

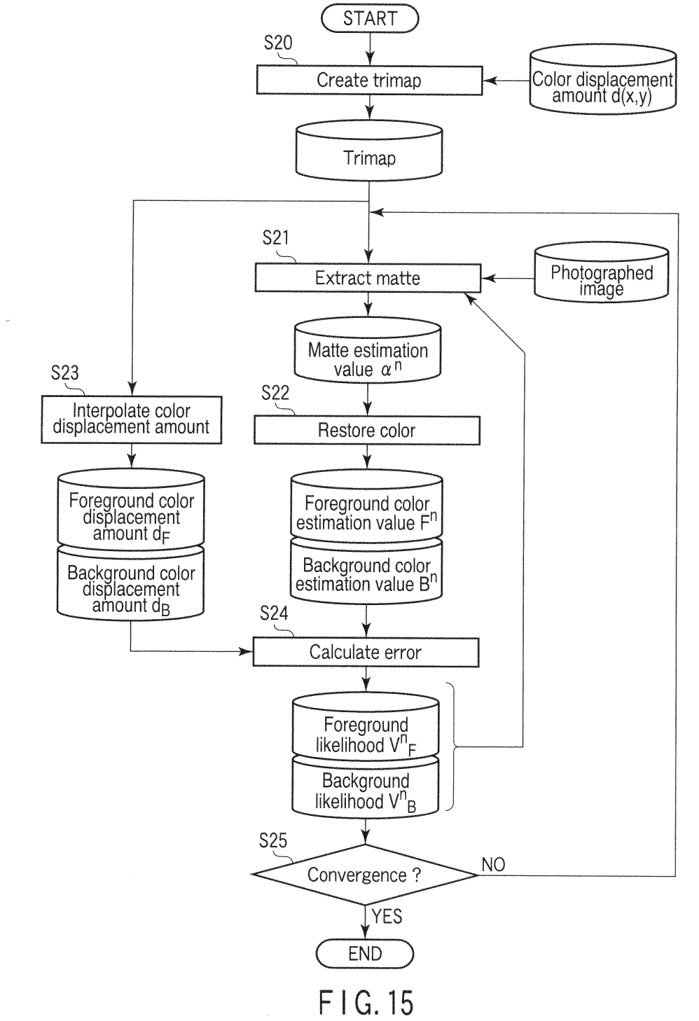

Next, the details of the foreground extraction unit 11 are described with reference to FIG. 15. FIG. 15 is a flow chart illustrating the operation of the foreground extraction unit 11. The foreground extraction unit 11 executes processes of steps S20 to S25 illustrated in FIG. 15, thereby extracting a foreground object from an image which is photographed by the camera 2. In this case, step S21, step S22 and step S24 are repeated an n-number of times (n: a natural number), thereby enhancing the precision of the foreground extraction.

The respective steps will be described below.

### <Step S20>

To start with, the foreground extraction unit 11 prepares a trimap by using the color displacement amount d (x,y) (or depth D (x,y)) which is found by the depth calculation unit 10. The trimap is an image in which an image is divided into three regions, i.e. a region which is strictly a foreground, a region which is strictly a background, and an unknown region which is unknown to be a foreground or a background.

When the trimap is prepared, the foreground extraction unit 11 compares the color displacement amount d (x,y) at each coordinate with a predetermined threshold dth, thereby dividing the region into a foreground region and a background region. For example, a region in which d>dth is set to be a background region, and a region in which d≦dth is set to be a foreground region. A region in which d=dth may be set to be an unknown region.

Subsequently, the foreground extraction region 11 broadens the boundary part between the two regions which are found as described above, and sets the broadened boundary part to be an unknown region.

Thus, a trimap, in which the entire region is painted and divided into a “strictly foreground” region Ω_{F}, a “strictly background” region Ω_{B}, and an “unknown” region Ω_{U}, is obtained.

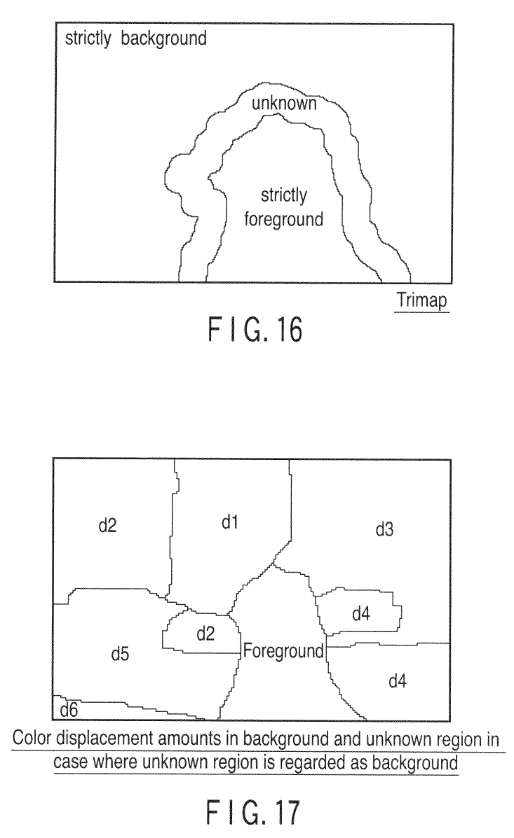

FIG. 16 shows a trimap which is obtained from the RGB images shown in FIG. 5.

### <Step S21>

Next, the foreground extraction unit 11 extracts a matte. The extraction of matte is to find, with respect to each coordinate, a mixture ratio α (x,y) between a foreground color and a background color in a model in which an input image I (x,y) is a linear blending between a foreground color F (x,y) and a background color B (x,y). This mixture ratio a is called “matte”. In the above-described model, the following equation (9) is assumed:

Ir(x,y)=α(x,y)·Fr(x,y)+(1−α(x,y))·Br(x,y)

Ig(x,y)=α(x,y)·Fg(x,y)+(1−α(x,y))·Bg(x,y)

Ib(x,y)=α(x,y)·Fb(x,y)+(1−α(x,y))·Bb(x,y) (9)

where a takes a value of [0, 1], and α=0 indicates a complete background and α=1 indicates a complete foreground. In other words, in a region of α=0, only the background appears. In a region of α=1, only the foreground appears. In the case where α takes an intermediate value (0<α<1), the foreground masks a part of the background at a pixel of interest.

In the above equation (9), if the number of pixels of image data, which is photographed by the camera 2, is denoted by M (M: a natural number), since it is necessary to solve for 7M unknowns α(x,y), Fr(x,y), Fg(x,y), Fb(x,y), Br(x,y), Bg(x,y) and Bb(x,y) given 3M measurements Ir(x,y), Ig(x,y), and Ib(x,y), there are an infinite number of solutions.

In the present embodiment, the matte α (x,y) of the “unknown” region Ω_{U} is interpolated from the “strictly foreground” region Ω_{F} and “strictly background” region Ω_{B} in the trimap. Further, solutions are corrected so that the foreground color F (x,y) and background color B (x,y) may agree with the color displacement amount which is estimated by the above-described depth estimation. However, if solutions are to be found with respect to a 7M number of variables, the equation will become a large-scale one and becomes complex. Thus, α, which minimizes the quadratic equation relating to the matte α shown in the following equation (10), is found:

αⁿ⁺¹(x,y)=arg min{Σ_{9x,y)}Vⁿ_{F}(x,y)·(1−α(x,y))²+Σ_{(x,y)}Vⁿ_{B}(x,y)·(α(x,y))²+Σ_{(x,y)}Σ_{(s,t)}∈_{z}(x,y) W(x,y;s,t)·(α(x,y)−α(s,t))²} (10)

where n is the number of times of repetition of step S21, step S22 and step S24,

Vⁿ_{F}(x,y) is the likelihood of an n-th foreground at (x,y),

Vⁿ_{B}(x,y) is the likelihood of an n-th background at (x,y),

z (x,y) is a local window centering on (x,y),

(s,t) is coordinates included in z (x,y),

W (x,y; s,t) is the weight of smoothness between (x,y) and (s,t), and

arg min means solving for x which gives a minimum value of E(x) in arg min {E(x)}, i.e. solving for a which minimizes the arithmetic result in parentheses following the arg min.

The local window, which is expressed by z (x,y), may have a size which is different from the size of the local window expressed by w (x,y) in equation (4). Although the details of Vⁿ_{F}(x,y) and Vⁿ_{B}(x,y) will be described later, Vⁿ_{F}(x,y) and Vⁿ_{B}(x,y) indicate how much the foreground and background are correct, respectively. As the Vⁿ_{F}(x,y) is greater, α (x,y) is biased toward 1, and as the Vⁿ_{B}(x,y) is greater, α (x,y) is biased toward 0.

However, when α (initial value α⁰) at a time immediately after the preparation of the trimap in step S20 is to be found, the equation (10) is solved by assuming Vⁿ_{F}(x,y)=Vⁿ_{B}(x,y)=0. From the estimated value αⁿ(x,y) of the current matte which is obtained by solving the equation (10), Vⁿ_{F}(x,y) and Vⁿ_{B}(x,y) are found. Then, the equation (10) is minimized, and the updated matte αⁿ⁺¹(x,y) is found.

In the meantime, W(x,y;s,t) is set at a fixed value, without depending on repetitions, and is found by using the following equation (11) from the input image I (x,y):

W(x,y;s,t)=exp(−|I(x,y)−I(s,t)|²/2σ²) (11)

where σ is a scale parameter. This weight increases when the color of the input image is similar between (x,y) and (s,t), and decreases as the difference in color increases. Thereby, the interpolation of matte from the “strictly foreground” region and “strictly background” region becomes smoother in the region where the similarity in color is high. In the “strictly foreground” region of the trimap, α (x,y)=1. And in the “strictly background” region of the trimap, α (x,y)=0. These serve as constraints in the equation (10).

### <Step S22>

Next, when Vⁿ_{F}(x,y) and Vⁿ_{B}(x,y) are to be found, the foreground extraction unit 11 first finds an estimation value Fⁿ(x,y) of the foreground color and an estimation value Bⁿ(x,y) of the background color, on the basis of the estimation value αⁿ(x,y) of the matte which is obtained in step S21.

Specifically, on the basis of the αⁿ(x,y) which is obtained in step S21, the color is restored. The foreground extraction unit 11 finds Fⁿ(x,y) and Bⁿ(x,y) by minimizing the quadratic expression relating to F and B, which is expressed by the following equation (12):

Fⁿ(x,y),Bⁿ(x,y)=arg min{Σ_{(x,y)}|I(x,y)−α(x,y)·F(x,y)−(1α(x,y))·B(x,y)|²+βΣ_{(x,y)}Σ_{(s,t)}∈_{z(x,y)}(F(x,y)−F(s,t))²+βΣ_{(x,y)}Σ_{(s,t)}∈_{z(x,y)}(B(x,y)−B(s,t))²} (12)

In equation (12), the first term is a constraint on F and B which requires the equation (9) be satisfied, the second term is a smoothness constraint on F, and the third term is a smoothness constraint on B. β is a parameter for adjusting the influence of smoothness. In addition, arg min in equation (12) means solving for F and B which minimize the arithmetic result in parentheses following the arg min.

Thus, the foreground color F (estimation value Fⁿ (x,y)) and the background color B (estimation value Bⁿ (x,y)) at the coordinates (x,y) are found.

### <Step S23>

Subsequently, the foreground extraction unit 11 executes interpolation of the color displacement amount, on the basis of the trimap that is obtained in step S20.

The present process is a process for calculating the color displacement amount of the unknown region Ω_{U} in cases where the “unknown” region Ω_{U} in the trimap is regarded as the “strictly foreground” region Ω_{F} and as the “strictly background” region Ω_{B}.

Specifically, to begin with, the estimated color displacement amount d, which is obtained in step S14, is propagated from the “strictly background” region to the “unknown” region. This process can be carried out by copying the values of those points in the “strictly background” region, which are closest to the respective points in the “unknown” region, to the values at the respective points in the “unknown” region. The estimated color displacement amount d (x,y) at each point of the “unknown” region, which is thus obtained, is referred to as the background color displacement amount d_{B} (x,y). As a result, the obtained color displacement amounts d in the “strictly background” region and “unknown” region are as shown in FIG. 17.

FIG. 17 shows the color displacement amounts d in the RGB images shown in FIG. 5.

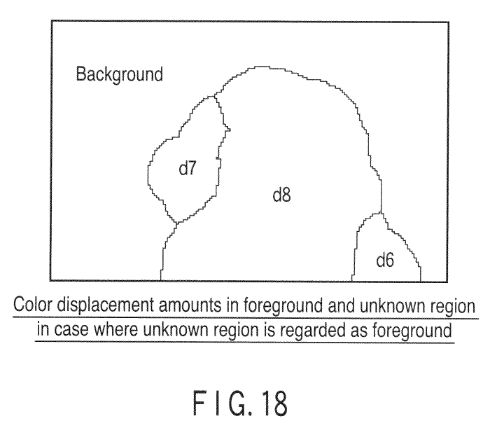

Similarly, the estimated color displacement amount d, which is obtained in step S14, is propagated from the “strictly foreground” region to the “unknown” region. This process can also be carried out by copying the values of the closest points in the “strictly foreground” region to the values at the respective points in the “unknown” region. The estimated color displacement amount d (x,y) at each point of the “unknown” region, which is thus obtained, is referred to as the foreground color displacement amount d_{F} (x,y). As a result, the obtained color displacement amounts d in the “strictly foreground” region and “unknown” region are as shown in FIG. 18.

FIG. 18 shows the color displacement amounts d in the RGB images shown in FIG. 5.

As a result of the above process, the foreground color displacement amount d_{F} (x,y) and the background color displacement amount d_{B} (x,y) are expressed by the following equation (13):

$$\begin{matrix}{d}_{F} ( x , y ) = d ( u , v ) s . t . ( u , v ) \\ = arg min \{ {( x - u )}^{2} + {( y - v )}^{2} \vert ( u , v ) ∈ {Ω}_{F} \}\end{matrix} \\ \begin{matrix}{d}_{B} ( x , y ) = d ( u , v ) s . t . ( u , v ) \\ = arg min \{ {( x - u )}^{2} + {( y - v )}^{2} \vert ( u , v ) ∈ {Ω}_{B} \}\end{matrix} \qquad ( 13 )$$

Coordinates (u, v) are the coordinates in the “strictly foreground” region and the “strictly background” region. As a result, each point (x,y) in the “unknown” region has two color displacement amounts, that is, a color displacement amount in a case where this point is assumed to be in the foreground, and a color displacement amount in a case where this point is assumed to be in the background.

### <Step S24>

After step S22 and step S23, the foreground extraction unit 11 finds the reliability of the estimation value Fⁿ (x,y) of the foreground color and the estimation value Bⁿ (x,y) of the background color, which are obtained in step S22, by using the foreground color displacement amount d_{F} (x,y) and the background color displacement amount d_{B} (x,y) which are obtained in step S23.

In the present process, the foreground extraction unit 11 first calculates a relative error E_{F} (x,y) of the estimated foreground color Fⁿ (x,y) and a relative error E_{B} (x,y) of the estimated background color Bⁿ (x,y), by using the following equation (14):

Eⁿ_{F}(x,y)=eⁿ_{F}(x,y,d_{F}(x,y))−eⁿ_{F}(x,y,d_{B}(x,y))

Eⁿ_{B}(x,y)=eⁿ_{B}(x,y,d_{B}(x,y))−eⁿ_{B}(x,y,d_{F}(x,y)) (14)

In the depth calculation unit 10, the error eₗᵢₙₑ (x,y; d) of the input image I, relative to the linear color model, was calculated. On the other hand, the foreground extraction unit 11 calculates the error of the foreground color Fⁿ and the error of the background color Bⁿ, relative to the linear color model. Accordingly, the eⁿ_{F} (x,y; d) and eⁿ_{B} (x,y; d) indicate the errors of the foreground color Fⁿ and the error of the background color Bⁿ, relative to the linear color model.

To begin with, the relative error E_{F} of the foreground color is explained. In a case where the estimated foreground color Fⁿ (x,y) is correct (highly reliable) at a certain point (x,y), the error eⁿ_{F} (x,y; d_{F} (x,y)) relative to the linear color model becomes small when the color displacement of the image is canceled by applying the foreground color displacement amount d_{F} (x,y). Conversely, if the color displacement of the image is canceled by applying the background color displacement amount d_{B} (x,y), the color displacement is not corrected because restoration is executed by the erroneous color displacement amount, and the error eⁿ_{F} (x,y; d_{B} (x,y)) relative to the linear color model becomes greater. Accordingly, Eⁿ_{F} (x,y)<0, if the foreground color is displaced as expected. If Eⁿ_{F} (x,y)>0, it indicates that the estimated value Fⁿ (x,y) of the foreground color has the color displacement which may be accounted for, rather, by the background color displacement amount, and it is highly possible that the background color is erroneously extracted as the foreground color in the neighborhood of the (x,y).

The same applies to the relative error Eⁿ_{B} of the background color. When the estimated background color Bⁿ (x,y) can be accounted for by the background color displacement amount, it is considered that the estimation is correct. Conversely, when the estimated background color Bⁿ (x,y) can be accounted for by the foreground color displacement amount, it is considered that the foreground color is erroneously taken into the background.

Using the above-described measure Eⁿ_{F} (x,y) and measure Eⁿ_{B} (x,y), the foreground extraction unit 11 finds the likelihood Vⁿ_{F} (x,y) of the foreground and the likelihood Vⁿ_{B} (x,y) of the background in the equation (10) by the following equation (15):

Vⁿ_{F}(x,y)=max{ηαⁿ(x,y)+γ(Eⁿ_{B}(x,y)−Eⁿ_{F}(x,y)), 0}

Vⁿ_{B}(x,y)=max{η(1−αⁿ(x,y))+γ(Eⁿ_{F}(x,y)−Eⁿ_{B}(x,y)), 0} (15)

where η is a parameter for adjusting the influence of the term which maintains the current matte estimation value αⁿ(x,y), and γ is a parameter for adjusting the influence of the color displacement term in the equation (10).

From the equation (15), in the case where the background relative error is greater than the foreground relative error, it is regarded that the foreground color is erroneously included in the estimated background color (i.e. α (x,y) is small when it should be large), and α (x,y) is biased toward 1 from the current value αⁿ (x,y). In addition, in the case where the foreground relative error is greater than the background relative error, α (x,y) is biased toward 0 from the current value αⁿ (x,y).

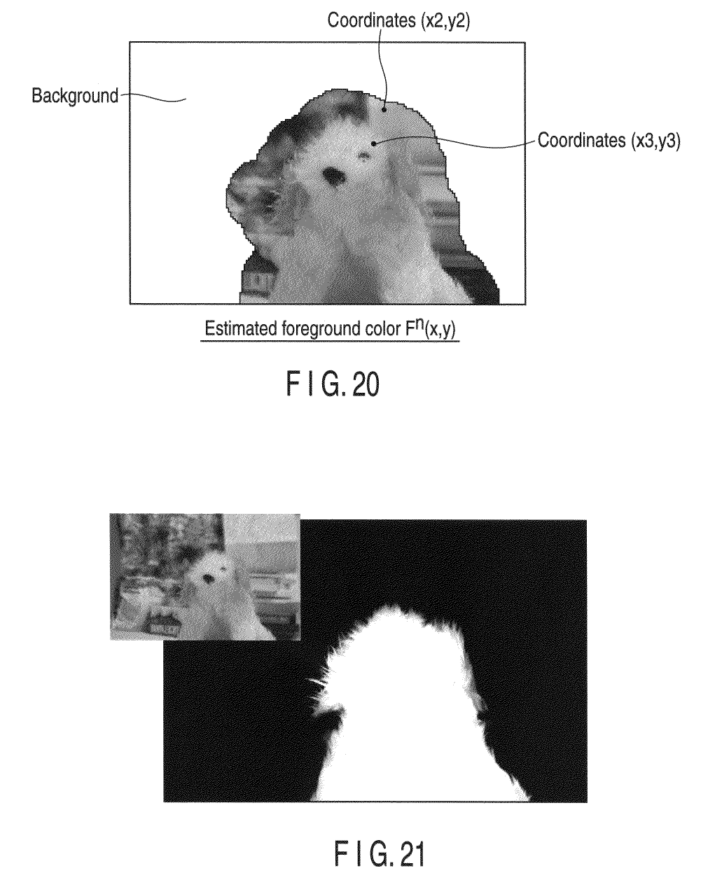

A concrete example of the above is described with reference to FIG. 19 and FIG. 20. For the purpose of simple description, consideration is given to the case in which the current matte estimation value is 0.5, i.e. αⁿ (x,y)=0.5. Then, the estimated background color Bⁿ (x,y), which is obtained by equation (12), is as shown in FIG. 19, and the estimated foreground color Fⁿ (x,y) is as shown in FIG. 20. Unknown regions in FIG. 19 and FIG. 20 become images of colors similar to the RGB image shown in FIG. 5.

To begin with, attention is paid to coordinates (x2,y2) in the unknown region. Actually, these coordinates are in the background. Then, the error eⁿ_{B}(x2,y2; d_{B}(x2,y2)) of the estimated background color Bⁿ(x2,y2) becomes less than the error eⁿ_{B}(x2,y2; d_{F}(x2,y2)). Accordingly, Eⁿ_{B}(x2,y2)<0. In addition, the error eⁿ_{F}(x2,y2; d_{F}(x2,y2)) of the estimated foreground color Fⁿ(x,y) is greater than the error eⁿ_{F}(x2,y2; d_{B}(x2,y2)). Accordingly, Eⁿ_{F}(x2,y2)>0. Thus, at the coordinates (x2,y2), Vⁿ_{F}(x2,y2)<ηαⁿ(x2,y2), and Vⁿ_{B}(x2,y2)>η(1−αⁿ(x2,y2)). As a result, it is understood that in equation (10), αⁿ⁺¹(x2,y2) is smaller than αⁿ(x2, y2), and becomes closer to 0, which indicates the background.

Next, attention is paid to coordinates (x3,y3) in the unknown region. Actually, these coordinates are in the foreground. Then, the error eⁿ_{F}(x3,y3; d_{F}(x3,y3)) of the estimated foreground color Fⁿ(x3,y3) is smaller than the error eⁿ_{F}(x3,y3; d_{B}(x3,y3)). Accordingly, Eⁿ_{F}(x3,y3)<0. In addition, the eⁿ_{B}(x3,y3; d_{B}(x3,y3)) of the estimated background Bⁿ(x,y) is greater than the error eⁿ_{B}(x3,y3; d_{F}(x3,y3)). Accordingly, Eⁿ_{B}(x2,y2)>0. Thus, at the coordinates (x3,y3), Vⁿ_{F}(x3,y3)>ηαⁿ(x3,y3), and Vⁿ_{B}(x3,y3)<η(1αⁿ(x3,y3)). As a result, it is understood that in equation (10), αⁿ⁺¹(x3,y3) is greater than αⁿ(x3,y3), and becomes closer to 1, which indicates the foreground.

If the above-described background relative error and foreground relative error come to convergence (YES in step S25), the foreground extraction unit 11 completes the calculation of the matte α. In other words, the mixture ratio α with respect to all pixels of the RGB image is determined. This may also be determined on the basis of whether the error has fallen below a threshold, whether the difference between the current matte αⁿ and the updated matte αⁿ⁺¹ is sufficiently small, or whether the number of times of repetition of step S21, step S22 and step S24 has reached a predetermined number. If the error does not come to convergence (NO in step S25), the process returns to step S21, and the above-described operation is repeated.

An image, which is obtained by the matte α (x,y) calculated in the foreground extraction unit 11, is a mask image shown in FIG. 21, that is, a matte. In FIG. 21, a black region is the background (α=0), a white region is the foreground (α=1), and a gray region is a region in which the background and foreground are mixed (0<α<1). As a result, the foreground extraction unit 11 can extract only the foreground object in the RGB image.

### <<Re: Image Compositing Unit 12>>

Next, the details of the image compositing unit 12 are described. The image compositing unit 12 executes various image processes by using the depth D (x,y) which is obtained by the depth calculation unit 10, and the matte α (x,y) which is obtained by the foreground extraction unit 11. The various image processes, which are executed by the image compositing unit 12, will be described below.

### <Background Compositing>

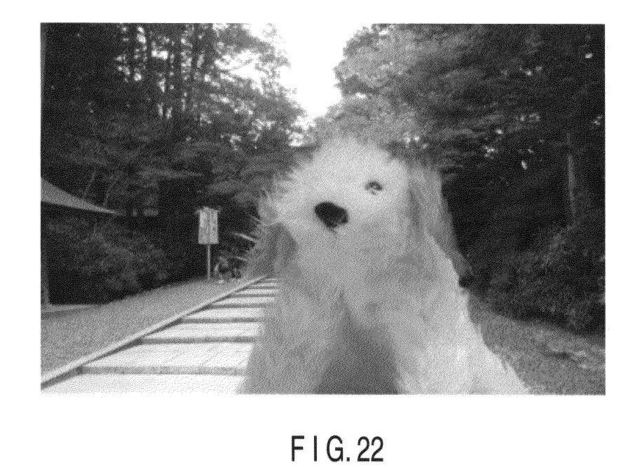

The image compositing unit 12 composites, for example, an extracted foreground and a new background. Specifically, the image compositing unit 12 reads out a new background color B′ (x,y) which the image compositing unit 12 itself has, and substitutes RGB components of the background color in Br (x,y), Bg (x,y) and Bb (x,y) in the equation (9). As a result, a composite image I′ (x) is obtained. This process is illustrated in FIG. 22.

FIG. 22 shows an image which illustrates how a new background and a foreground of an input image I are composited. As shown in FIG. 22, the foreground (stuffed toy dog) in the RGB image shown in FIG. 5 is composited with the new background.

### <Focal Blurring Correction>

The color displacement amount d (x,y), which is obtained in the depth calculation unit 10, corresponds directly to the amount of focal blurring at the coordinates (x,y). Thus, the image compositing unit 12 can eliminate focal blurring by deconvolving such a point-spread function that the length of one side of each square of the filter regions 20 to 22 shown in FIG. 2 is d (x,y)·\sqrt{2}.

In addition, by blurring the image, from which the focal blurring has been eliminated, in a different blurring manner, the degree of focal blurring can be varied. At this time, by displacing the R image, G image and B image so as to cancel the estimated color displacement amounts, an image which is free from color displacement can be obtained even in an out-of-focus region.

### <3-D Image Structure>

Since the depth D (x,y) is found in the depth calculation unit 10, an image seen from a different view point can also be obtained.

### <<Advantageous Effects>>

As has been described above, with the image processing method according to the first embodiment of the present invention, compared to the prior art, the depth of a scene can be estimated by a simpler method.

According to the method of the present embodiment, a three-color filter of RGB is disposed at the aperture of the camera, and a scene is photographed. Thereby, images, which are substantially photographed from three view points, can be obtained with respect to one scene. In the present method, it should suffice if the filter is disposed and photographing is performed. There is no need to modify image sensors and photographing components other than the camera lens. Therefore, a plurality of images, as viewed from a plurality of view points, can be obtained from one RGB image.

Moreover, compared to the method disclosed in document 1, which has been described in the section of the background art, the resolution of the camera is sacrificed. Specifically, in the method of document 1, the micro-lens array is disposed at the image pickup unit so that a plurality of pixels may correspond to the individual micro-lenses. The respective micro-lenses refract light which is incident from a plurality of directions, and the light is recorded on the individual pixels. For example, if images from four view points are to be obtained, the number of effective pixels in each image obtained at each view point becomes ¼ of the number of all pixels, which corresponds to ¼ of the resolution of the camera.

In the method of the present embodiment, however, each of the images obtained with respect to plural view points can make use of all pixels corresponding to the RGB of the camera. Therefore, the resolution corresponding to the RGB, which is essentially possessed by the camera, can effectively be utilized.

In the present embodiment, the error eₗᵢₙₑ (x,y; d) from the linear color model, relative to the supposed color displacement amount d, can be found with respect to the obtained R image, G image and B image. Therefore, the color displacement amount d (x,y) can be found by the stereo matching method by setting this error as the measure, and, hence, the depth D of the RGB image can be found.

If photographing is performed by setting a focal point at the foreground object, it is possible to extract the foreground object by separating the background on the basis of the estimated depth using the color displacement amounts. At this time, the mixture ratio α between the foreground color and the background color is found in consideration of the color displacement amounts.

To be more specific, after preparing the trimap on the basis of the color displacement amount d, when the matte a with respect to the “unknown” region is calculated, calculations are performed for the error from the linear color model at the time when this region is supposed to be a foreground and the error from the linear color model at the time when this region is supposed to be a background. Then, estimation is performed as to how much the color of this region is close to the color of the foreground, or how much the color of this region is close to the color of the background, in terms of color displacement amounts. Thereby, high-precision foreground extraction is enabled. This is particularly effective at the time of extracting an object with a complex, unclear outline, such as hair or fur, or an object with a semitransparent part.

The estimated color displacement amount d agrees with the degree of focal blurring. Thus, a clear image, from which focal blurring is eliminated, can be restored by subjecting the RGB image to a focal blurring elimination process by using a point-spread function with a size of the color displacement amount d. In addition, by blurring an obtained clear image on the basis of the depth D (x,y), it is possible to create an image with a varied degree of focal blurring, with the effect of a variable depth-of-field or a variable focused depth.

### Second Embodiment

Next, an image processing method according to a second embodiment of the present invention is described. The present embodiment relates to the measure at the time of using the stereo matching method, which has been described in connection with the first embodiment. In the description below, only the points different from the first embodiment are explained.

In the first embodiment, the error eₗᵢₙₑ (x,y; d), which is expressed by the equation (8), is used as the measure of the stereo matching method. However, the following measures may be used in place of the eₗᵢₙₑ (x,y; d).

### EXAMPLE 1 OF OTHER MEASURES

The straight line 1 (see FIG. 9) in the three-dimensional color space of RGB is also a straight line when the straight line 1 is projected on the RG plane, GB plane and BR plane. Consideration is now given to a correlation coefficient which measures the linear relationship between two arbitrary color components. If the correlation coefficient between the R component and G component is denoted by Crg, the correlation coefficient between the G component and B component is Cgb and the correlation coefficient between the B component and R component is Cbr, the Crg, Cgb and Cbr are expressed by the following equations (16):

Crg=cov(Ir,Ig)/{square root over ((var(Ir)var(Ig)))}

Cgb=cov(Ig,Ib)/{square root over ((var(Ig)var(Ib)))}

Cbr=cov(Ib,Ir)/{square root over ((var(Ib)var(Ir)))} (16)

where −1≦Crg≦1, −1≦Cgb≦1, and −1≦Cbr≦1. It is indicated that as the value |Crg| is greater, a stronger linear relationship exists between the R component and G component. The same applies to Cgb and Cbr, and it is indicated that as the value |Cgb| is greater, a stronger linear relationship exists between the G component and B component, and as the value |Cbr| is greater, a stronger linear relationship exists between the B component and R component.

As a result, the measure e_{corr}, which is expressed by the following equation (17), is obtained:

e_{corr}(x,y;d)=1−(C²rg+C²gb+C²br)/3 (17)

Thus, e_{corr} may be substituted for eₗᵢₙₑ (x,y; d) as the measure.

### EXAMPLE 2 OF OTHER MEASURES

By thinking that a certain color component is a linear combination of two components, a model of the following equation (18) may be considered:

Ig(s,t−d)=cᵣ·Ir(s+d,t)+c_{b}·Ib(s−d,t)+c_{c} (18)

where cᵣ, c_{b} and c_{c} are a linear coefficient between the G component and R component, a linear coefficient between the G component and B component, and a constant part of the G component. These linear coefficients can be found by solving a least-squares method in each local window w(x,y).

As a result, the index e_{comb}(x,y;d), which is expressed by the following equation (19), can be obtained:

e_{comb}(x,y;d)=Σ_{(s,t)}∈_{w(x,y)}|Ig(s,t−d)−cᵣ·Ir(s+d,t)−c_{b}·Ib(s−d,t)−c_{c}|² (19)

Thus, e_{comb} may be substituted for eₗᵢₙₑ (x,y; d) as the measure.

### EXAMPLE 3 OF OTHER MEASURES

A measure e_{det} (x,y; d), which is expressed by the following equation (20), may be considered by taking into account not only the largest eigenvalue λₘₐₓ of the covariance matrix S of the pixel color in the local window, but also the other two eigenvalues λ_{mid} and λₘᵢₙ.

e_{det}(x,y; d)=λₘₐₓλ_{mid}λₘᵢₙ/S₀₀S₁₁S₂₂ (20)

From the property of the matrix, λₘₐₓ+λ_{mid}+λₘᵢₙ=S₀₀+S₁₁+S₂₂. Hence, the e_{det} (x,y; d) decreases when the λₘₐₓ is greater than the other eigenvalues, and this means that the distribution is linear.

Thus, e_{det} (x,y; d) may be substituted for eₗᵢₙₑ (x,y; d) as the measure. Since λₘₐₓλ_{mid}λₘᵢₙ is equal to the determinant det(S) of the covariance matrix S, e_{det} (x,y; d) can be calculated without directly finding eigenvalues.

### <<Advantageous Effects>>

As has been described above, eₗᵢₙₑ(x,y; d), which has been described in the first embodiment, may be considered as a substitute for e_{corr}(x,y; d), e_{comb}(x,y; d), or e_{det}(x,y; d). If these measures are used, in the first embodiment, the calculation of the eigenvalue, which has been described in connection with the equation (7), becomes unnecessary. Therefore, the amount of computations in the image processing apparatus 4 can be reduced.

Each of the indices eₗᵢₙₑ, e_{corr}, e_{comb}, and e_{det} makes use of the presence of the linear relationship between color components. In addition, it is necessary to calculate the sum of pixel values within the local window, the sum of squares of each color component and the sum of the product of two components. The speed of this calculation can be increased by looking up a table with use of a summed area table (also called “integral image”).

### Third Embodiment

Next, an image processing method according to a third embodiment of the present invention is described. This embodiment relates to another example of the filter 3 in the first and second embodiments. In the description below, only the differences from the first and second embodiments are explained.

In the case of the filter 3 shown in FIG. 2, which has been described in connection with the first embodiment, the three regions 20 to 22 are congruent in shape, and the displacements are along the X axis and Y axis. With this structure, the calculation in the image process is simplified. However, the structure of the filter 3 is not limited to FIG. 2, and various structures are applicable.

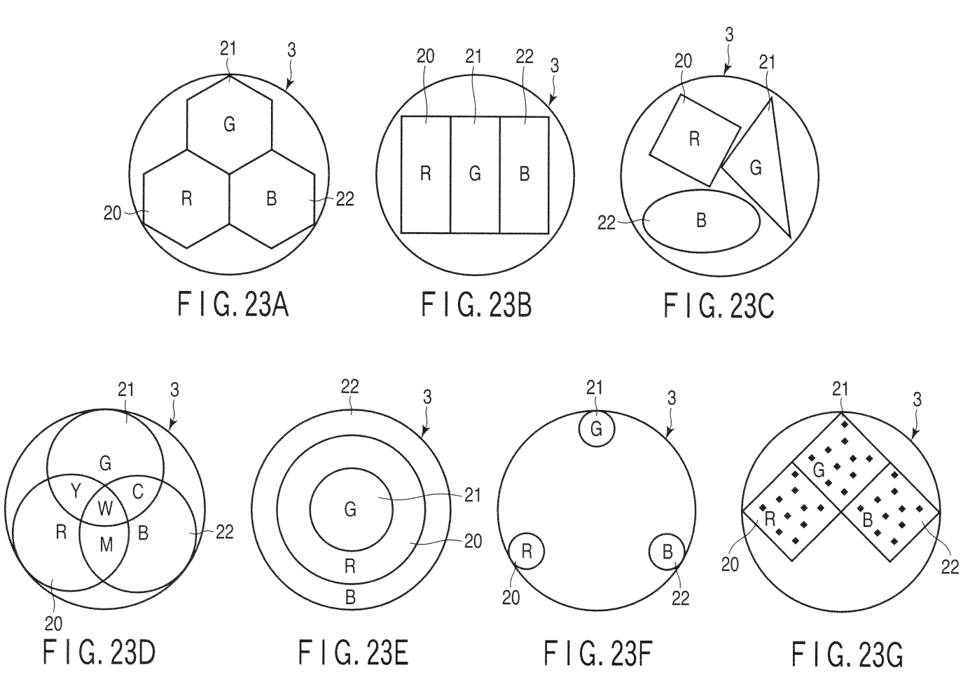

FIGS. 23A to 23G are external appearance views showing the structures of the filter 3. In FIGS. 23A to 23G, the plane that is parallel to the image pickup plane of the camera 2 is viewed in the frontal direction. In FIGS. 23A to 23G, regions, which are not indicated by R,G,B, Y, C, M and W, are regions which do not pass light.

To begin with, as shown in FIG. 23A, displacements of the three regions 20 to 22 may not be along the X axis and Y axis. In the example of FIG. 23A, the axes extending from the center of the lens 2a to the centers of the regions 20 to 22 are separated by 120° from each other. In the case of FIG. 23A, the R component is displaced in a lower left direction, the G component is displaced in an upward direction, and the B component is displaced in a lower right direction. In addition, the shape of each of the regions 20 to 22 may not be rectangular, and may be, for instance, hexagonal. In this structure, since the displacement is not along the X axis and Y axis, it is necessary to perform re-sampling of pixels in the image process. However, compared to the structure shown in FIG. 2, the amount of light passing through the filter 3 is greater, so the signal-to-noise ratio (SNR) can be improved.

As shown in FIG. 23B, the regions 20 to 22 may be disposed in the horizontal direction (X axis in the image pickup plane). In the example of FIG. 23B, the R component is displaced leftward and the B component is displaced rightward, but the G component is not displaced. In other words, if the displacement amounts of the respective regions 20 to 22 are different, the displacement amounts of the three components of the RGB image become different proportionally.

As shown in FIG. 23D, transmissive regions of the three wavelengths may be overlapped. In this case, a region, where the region 20 (R filter) and region 21 (G filter) overlap, functions as a filter of yellow (a region indicated by character “Y”, which passes both the R component and G component). A region, where the region 21 (G filter) and region 22 (B filter) overlap, functions as a filter of cyan (a region indicated by character “C”, which passes both the G component and B component). Further, a region, where the region 22 (B filter) and region 20 (R filter) overlap, functions as a filter of magenta (a region indicated by character “M”, which passes both the B component and R component). Accordingly, compared to the case of FIG. 23A, the transmission amount of light increases. However, since the displacement amount decreases by the degree corresponding to the overlap of the regions, the estimation precision of the depth D is better in the case of FIG. 23A. A region (indicated by character “W”), where the regions 20 to 22 overlap, passes all right of RGB.

In a manner converse to the concept shown in FIG. 23D, if the displacement amount is maximized, at the cost of decreasing the transmission amount of light, a structure shown in FIG. 23F is obtained. Specifically, the regions 20 to 22 are disposed so as to be out of contact with each other and to be in contact with the outer peripheral part of the lens 2a. In short, the displacement amount is increased by increasing the distance between the center of the lens 2a and the center of the regions 20 to 22.

As shown in FIG. 23G, light-blocking regions (regions indicated by black square marks in FIG. 23G) may be provided. Specifically, by providing patterns in the filter 3, the shapes of the regions 20 to 22 may be made complex. In this case, compared to the case in which light-blocking regions are not provided, the light transmission amount decreases, but the frequency characteristics of focal blurring are improved. Therefore, there is the advantage that focal blurring can more easily be eliminated.

In the case of the above-described filter 3, the shapes of the regions 20 to 22, which pass the three components of light, are congruent. The reason for this is that the point-spread function (PSF), which causes focal blurring, is determined by the shape of the color filter, and if the shapes of the three regions 20 to 22 are made congruent, the focal blurring of each point in the scene depends only on the depth and becomes equal between the R component, G component and B component.

However, for example, as shown in FIG. 23C, the shapes of the regions 20 to 22 may be different. In this case, too, if the displacements of the filter regions are sufficiently different, the color components are photographed with displacement. Hence, if the difference in point-spread function can be reduced by filtering, the process, which has been described in connection with the first and second embodiments, can be applied. In other words, for example, if high-frequency components are extracted by using a high-pass filter, the difference in focal blurring can be reduced. However, in the case where the shapes of the regions 20 to 22 are the same, the precision will be higher since the photographed image can directly be utilized.

As shown in FIG. 23E, the regions 20 to 22 may be disposed concentric about the center of the lens 2a. In this case, the displacement amount of each of the R component, G component and B component is zero. However, since the shapes and the sizes of the filter regions are different, the focal blurring is different among the color components, and the magnitude of the focal blurring amount (proportionally related to the displacement amount) can be used in place of the color displacement amount.

As has been described above, in the image processing methods according to the first to third embodiments of the present invention, an object is photographed by the camera 2 via the filter including the first filter region 20 which passes red light, the second filter region 21 which passes green light and the third filter region 22 which passes blue light. The image data obtained by the photographing by means of the camera 2 is separated into the red component (R image), green component (G image) and blue component (B image). The image process is performed by using these red component, green component and blue component. Thereby, a three-view-point image can be obtained by a simple method, without the need for a device other than the filter 3 in the camera 2.

In addition, stereo matching is performed by using, as the measure, the displacement in pixel value in the three-view-point image, relative to the linear color model in the 3-D color space. Thereby, the correspondency of pixels in the respective red component, green component and blue component can be detected, and the depth of each pixel can be found in accordance with the displacement amounts (color displacement amounts) between the positions of pixels.

Furthermore, after preparing the trimap in accordance with the displacement amount, calculations are performed for the error of the pixel value from the linear color model at the time when an unknown region is supposed to be a foreground and the error of the pixel value from the linear color model at the time when the unknown region is supposed to be a background. Then, on the basis of the displacement amount, the ratio between the foreground and background in the unknown region is determined. Thereby, high-precision foreground extraction is enabled.

The camera 2, which is described in the embodiments, may be a video camera. Specifically, for each frame in a motion video, the process, which has been described in connection with the first and second embodiments, may be executed. The system 1 itself does not need to have the camera 2. In this case, for example, image data, which is an input image, may be delivered to the image processing apparatus 4 via a network.

The above-described depth calculation unit 10, foreground extraction unit 11 and image compositing unit 12 may be realized by either hardware or software. In short, as regards the depth calculation unit 10 and foreground extraction unit 11, it should suffice if the process, which has been described with reference to FIG. 4 and FIG. 15, is realized. Specifically, in the case where these units are realized by hardware, the depth calculation unit 10 is configured to include a color conversion unit, a candidate image generating unit, an error calculation unit, a color displacement amount estimation unit, and a depth calculation unit, and these units are caused to execute the processes of steps S11 to S15. In addition, the foreground extraction unit 11 is configured to include a trimap preparing unit, a matte extraction unit, a color restoration unit, an interpolation unit and an error calculation unit, and these units are caused to execute the processes of Step S20 to S24. In the case of implementation by software, for example, a personal computer may be configured to function as the above-described depth calculation unit 10, foreground extraction unit 11 and image compositing unit 12.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing method comprising:
photographing an object by a camera via a filter including a first filter region which passes red light, a second filter region which passes green light and a third filter region which passes blue light;
separating image data, which is obtained by photographing by the camera, into a red component, a green component and a blue component;
determining a relationship of correspondency between pixels in the red component, the green component and the blue component, with reference to departure of pixel values in the red component, the green component and the blue component from a linear color model in a three-dimensional color space;
finding a depth of each of the pixels in the image data in accordance with positional displacement amounts of the corresponding pixels of the red component, the green component and the blue component; and
processing the image data in accordance with the depth.

2. The image processing method according to claim 1, wherein said processing the image data includes:
dividing the image data into a region which becomes a background and a region which becomes a foreground in accordance with the depth; and
extracting the foreground from the image data in accordance with a result of the division of the image data into the region which becomes the background and the region which becomes the foreground.

3. The image processing method according to claim 2, wherein said processing the image data includes compositing the foreground, which is extracted from the image data, and a new background.

4. The image processing method according to claim 1, wherein said processing the image data includes eliminating focal blurring in the image data in accordance with the positional displacement amounts of the corresponding pixels of the red component, the green component and the blue component.

5. The image processing method according to claim 1, wherein said processing the image data includes synthesizing image with a varied view point in accordance with the depth.

6. The image processing method according to claim 2, wherein a relationship of correspondency between the pixels in the image data and the pixels in the red component, the green component and the blue component is determined with reference to departure of pixel values in the red component, the green component and the blue component from the linear color model in the three-dimensional color space, and
said dividing the image data into the region which becomes the background and the region which becomes the foreground includes:
dividing the image data into a region which becomes the background, a region which becomes the foreground and an unknown region which is unknown to be the background or the foreground, with reference to the positional displacement amounts of the corresponding pixels of the red component, the green component and the blue component;
calculating the departure of the pixel values from the linear color model in the three-dimensional color space, assuming that the unknown region is the background;
calculating the departure of the pixel values from the linear color model in the three-dimensional color space, assuming that the unknown region is the foreground; and
determining a ratio of the foreground and a ratio of the background in the unknown region on the basis of the departures which are calculated by assuming that the unknown region is the background and that the unknown region is the foreground.

7. The image processing method according to claim 1, wherein said determining the relationship of correspondency between the pixels in the red component, the green component and the blue component includes:
calculating an error between a principal axis, on one hand, which is obtained from a point set including the pixels located at a plurality of second coordinates in the red component, the green component and the blue component, which are obtained by displacing coordinates from first coordinates, and pixels around the pixels located at the plurality of second coordinates, and each of pixel values of the pixels included in the point set, on the other hand, in association with the respective second coordinates in the three-dimensional color space; and
finding the second coordinates which minimize the error,
the pixels at the second coordinates, which minimize the error, correspond in the red component, the green component and the blue component, and
the positional displacement amounts of the pixels correspond to displacement amounts between the second coordinates of the pixels, which minimize the error, and the first coordinates.

8. The image processing method according to claim 6, wherein said determining the ratio of the foreground and the ratio of the background includes determining the ratio of the foreground and the ratio of the background in such a manner that the departure of the pixel values from the linear color model in the three-dimensional color space becomes smaller when the unknown region is assumed to be the foreground with respect to a foreground color image which is calculated from the ratio of the foreground, and that the departure of the pixel values from the linear color model in the three-dimensional color space becomes smaller when the unknown region is assumed to be the background with respect to a background color image which is calculated from the ratio of the background.

9. The image processing method according to claim 1, wherein the filter is configured such that the first filter region, the second filter region and the third filter region have congruent rectangular shapes, and displacements of the first filter region, the second filter region and the third filter region are along an X axis and a Y axis in an image pickup plane.

10. The image processing method according to claim 1, wherein the filter is configured such that the first filter region, the second filter region and the third filter region have congruent hexagonal shapes, and centers of the first filter region, the second filter region and the third filter region are separated by 120° from each other with respect to a center of a lens.

11. The image processing method according to claim 1, wherein the filter is configured such that the first filter region, the second filter region and the third filter region have congruent rectangular shapes, and the first filter region, the second filter region and the third filter region are disposed along an X axis in an image pickup plane.

12. The image processing method according to claim 1, wherein the filter is configured such that the first filter region, the second filter region and the third filter region have different shapes.

13. The image processing method according to claim 1, wherein the filter is configured such that the first filter region, the second filter region and the third filter region have congruent circular shapes, and transmissive regions of three wavelengths overlap each other.

14. The image processing method according to claim 1, wherein the filter is configured such that the first filter region, the second filter region and the third filter region are disposed concentrically about a center of a lens.

15. The image processing method according to claim 1, wherein the filter is configured such that the first filter region, the second filter region and the third filter region have congruent circular shapes, and are so disposed as to be out of contact with each other and to be in contact with an outer peripheral part of a lens.

16. The image processing method according to claim 1, wherein the filter includes the first filter region, the second filter region and the third filter region, and light-blocking regions are provided in the first filter region, the second filter region and the third filter region.

17. The image processing method according to claim 1, wherein said finding the depth of each of the pixels in the image data is executed by a stereo matching method using eₗᵢₙₑ (x,y; d) as an index.

18. The image processing method according to claim 1, wherein said finding the depth of each of the pixels in the image data is executed by a stereo matching method using e_{corr} (x,y; d) as an index.

19. The image processing method according to claim 1, wherein said finding the depth of each of the pixels in the image data is executed by a stereo matching method using e_{comb} (x,y; d) as an index.

20. The image processing method according to claim 1, wherein said finding the depth of each of the pixels in the image data is executed by a stereo matching method using e_{det} (x,y; d) as an index.
